(19) United States
(12) Patent Application Publication
(10) Pub. No.: US 2025/0355894 A1
(43) Pub. Date: Nov. 20, 2025

(54) UNIVERSAL DATA REPRESENTATION FOR HETEROGENEOUS DATA

(71) Applicant: View Systems, Inc., Dover, DE (US)

(72) Inventors: Joel Christner, El Dorado Hills, CA (US); Keith Barto, Pine, CO (US); Blake Martz, San Diego, CA (US); Alex Nogle, Carlsbad, CA (US); Yipeng Li, Campbell, CA (US)

(73) Assignee: View Systems, Inc., Dover, DE (US)

(21) Appl. No.: 19/213,979

(22) Filed: May 20, 2025

Related U.S. Application Data
(60) Provisional application No. 63/649,877, filed on May 20, 2024.

(51) Int. Cl. G06F 16/25; G06F 16/93

(52) U.S. Cl. CPC G06F 16/258; G06F 16/93

(57) ABSTRACT

This disclosure provides methods, devices, and systems for metadata extraction. The present implementations more specifically relate to a universal data representation (UDR) for heterogeneous data. As used herein, the term “UDR” refers to a metadata format that can be used to represent source data from various source data repositories and/or source content types. More specifically, metadata can be extracted from various content items and stored in respective UDR documents that describe heterogenous data in a common format. In other words, UDR documents share a common schema regardless of the schema or format of the source content. For example, a UDR data structure for a text document can have the same (or substantially similar) format as a UDR data structure for a relational database. Accordingly, UDR can significantly reduce data processing complexity by reducing the number of disparate data representations that must be understood by a data processing pipeline and/or application.

### CROSS-REFERENCE TO RELATED APPLICATIONS

This application claims priority and benefit under 35 U.S.C. § 119 (e) to U.S. Provisional Patent Application No. 63/649,877, filed May 20, 2024, which is incorporated herein by reference in its entirety.

### TECHNICAL FIELD

This disclosure relates generally to data management in computer systems, and specifically to a universal data representation (UDR) for heterogeneous data.

### DESCRIPTION OF RELATED ART

Many businesses store and use data of various types (including structured data and unstructured data), each having its own layout and semantics configured for the applications and/or users producing or consuming the data. Some businesses may benefit by leveraging such data assets as a means of yielding business insights (such as analytics) or creating transformative experiences, such as those provided through machine learning. Machine learning (also referred to as “artificial intelligence”) is a technique for improving the ability of a computer system or application to perform a certain task. Machine learning can be generally broken down into two component parts: training and inferencing. During the training phase, a machine learning system is provided with one or more “answers” and a large volume of raw training data associated with the answers. The machine learning system analyzes the training data to learn a set of rules (also referred to as a machine learning “model”) that can be used to describe each of the answers. During the inference phase, the machine learning system may infer answers from new data using the learned set of rules.

The heterogeneity of data poses several challenges to achieving such insights or machine learning models. Because different types of data can have different representations, layouts, and/or semantics, preparing such data for use by a computer system can introduce even more heterogeneity, which can further complicate the processing of the prepared data. Thus, new data management and preprocessing techniques are needed to simplify the processing of prepared data.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

One innovative aspect of the subject matter of this disclosure can be implemented in a method of constructing a searchable database. The method includes steps of receiving a first content item associated with a first content type; receiving a second content item associated with a second content type different than the first content type; extracting metadata from each of the first content item and the second content item; generating a first document that includes the metadata from the first content item arranged according to a predefined schema; generating a second document that includes the metadata from the second content item arranged according to the predefined schema; and storing the first document and the second document in a data repository that is searchable based on the predefined schema.

Another innovative aspect of the subject matter of this disclosure can be implemented in a data orchestration system, including a processing system and a memory. The memory stores instructions that, when executed by the processing system, cause the data orchestration system to receive a first content item associated with a first content type; receive a second content item associated with a second content type different than the first content type; extract metadata from each of the first content item and the second content item; generate a first document that includes the metadata from the first content item arranged according to a predefined schema; generate a second document that includes the metadata from the second content item arranged according to the predefined schema; and store the first document and the second document in a data repository that is searchable based on the predefined schema.

### BRIEF DESCRIPTION OF THE DRAWINGS

The present implementations are illustrated by way of example and are not intended to be limited by the figures of the accompanying drawings.

FIG. 1 shows a block diagram of an example data orchestration system, according to some implementations.

FIG. 2 shows an example universal data representation (UDR) extraction system, according to some implementations.

FIGS. 3A and 3B show an example UDR document, according to some implementations.

FIG. 4A shows an example content item.

FIG. 4B shows an example schema that can be extracted from the content item of FIG. 3A, according to some implementations.

FIG. 4C shows an example flattened representation of objects included in the content item of FIG. 4A, according to some implementations.

FIG. 5A shows another example content item.

FIG. 5B shows an example inverted index that can be generated based on the content item of FIG. 5A, according to some implementations.

FIG. 5C shows an example semantic cell representation of the content item of FIG. 5A, according to some implementations.

FIG. 6 shows an example data management system, according to some implementations.

FIG. 7 shows an example search query that can be provided as input to the hybrid search engine of FIG. 6.

FIG. 8 shows a block diagram of an example retrieval augmented generation (RAG) system, according to some implementations.

FIG. 9 shows another block diagram of an example data orchestration system, according to some implementations.

FIG. 10 shows an illustrative flowchart depicting an example operation for constructing a searchable database, according to some implementations.

### DETAILED DESCRIPTION

In the following description, numerous specific details are set forth such as examples of specific components, circuits, and processes to provide a thorough understanding of the present disclosure. The term “coupled” as used herein means connected directly to or connected through one or more intervening components or circuits. The terms “electronic system” and “electronic device” may be used interchangeably to refer to any system capable of electronically processing information. Also, in the following description and for purposes of explanation, specific nomenclature is set forth to provide a thorough understanding of the aspects of the disclosure. However, it will be apparent to one skilled in the art that these specific details may not be required to practice the example implementations. In other instances, well-known circuits and devices are shown in block diagram form to avoid obscuring the present disclosure. Some portions of the detailed descriptions which follow are presented in terms of procedures, logic blocks, processing and other symbolic representations of operations on data bits within a computer memory.

These descriptions and representations are the means used by those skilled in the data processing arts to most effectively convey the substance of their work to others skilled in the art. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system. It should be borne in mind, however, that all of these and similar terms are to be associated with the appropriate physical quantities and are merely convenient labels applied to these quantities.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

In the figures, a single block may be described as performing a function or functions; however, in actual practice, the function or functions performed by that block may be performed in a single component or across multiple components, or may be performed using hardware, using software, or using a combination of hardware and software. To clearly illustrate this interchangeability of hardware and software, various illustrative components, blocks, modules, circuits, and steps have been described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example systems or devices may include components other than those shown, including well-known components such as a processor, memory and the like.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium including instructions that, when executed, performs one or more of the methods described herein. The non-transitory processor-readable data storage medium may form part of a computer program product, which may include packaging materials.

The non-transitory processor-readable storage medium may comprise random access memory (RAM) such as synchronous dynamic random-access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, or executed by a computer or other processor.

The various illustrative logical blocks, modules, circuits and instructions described in connection with the implementations disclosed herein may be executed by one or more processors (or a processing system). The term “processor,” as used herein may refer to any general-purpose processor, special-purpose processor, conventional processor, controller, microcontroller, or state machine capable of executing scripts or instructions of one or more software programs stored in memory.

Various aspects relate generally to systems and techniques for data management, and more particularly, to a universal data representation (UDR) for heterogeneous data. As used herein, the term “UDR” refers to a metadata format that can be used to represent source data from various source data repositories (such as file servers, object stores, and structured query language (SQL) databases) and/or source content type (such as text documents, JavaScript Object Notation (JSON) files, HyperText Markup Language (HTML) documents, PowerPoint (PPTX) presentations, and SQL databases). More specifically, metadata can be extracted from various content items and stored in respective UDR documents that describe heterogenous data in a common (or “universal”) format. In other words, UDR documents share a common schema regardless of the schema or format of the source content. For example, a UDR data structure for a text document can have the same (or substantially similar) format as a UDR data structure for a relational database. Accordingly, UDR can significantly reduce data processing complexity by reducing the number of disparate data representations that must be understood and handled by a data processing pipeline and/or application. UDR also provides a consistent structure against which queries can be executed to power data discovery and broader data management use cases.

With a common metadata format, users can execute queries against UDR documents, which have a consistent schema and format, without having to understand the intricacies and/or complexities of the source data format or the source data repositories themselves. Thus, UDR enables a user to query data, regardless of its source repository or source content type, along any number of dimensions. Example suitable dimensions include presence of a keyword, presence of multiple keywords, presence of multiple keywords with minimum and maximum distances amongst them, content-type, source repository, data owner, existence of schema elements, existence of schema elements with specific value types, specific values, or values that fall within a given range (determined using Boolean operations), and similarity of embeddings based on any number of search mechanisms (such as cosine similarity, nearest neighbor, or inner product), among other examples.

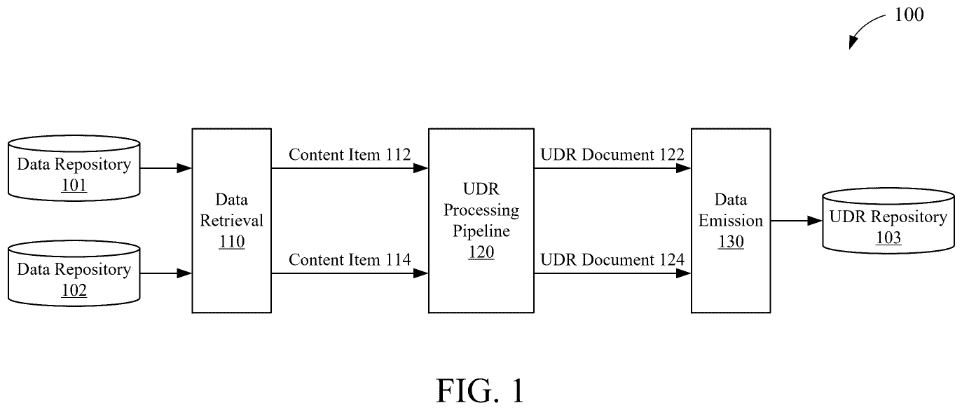

FIG. 1 shows a block diagram of an example data orchestration system 100, according to some implementations. The data orchestration system 100 is configured to retrieve content items 112 and 114 from respective data repositories 101 and 102, convert the content items 112 and 114 to respective UDR documents 122 and 124, and emit the resulting UDR documents 122 and 124 to a UDR repository 103.

Each content item 112 and 114 can be a digital document, file, or other data structure of any type (such as images, videos, slideshow presentations, word processing documents, SQL databases, JavaScript Object Notation (JSON) files, and HyperText Markup Language (HTML) documents, among other examples). In some implementations, the first content item 112 may be associated with a different content type than the second content item 114. For example, the first content item 112 can be a text document and the second content item 114 can be a relational database. In the example of FIG. 1, the content items 112 and 114 are stored in different data repositories 101 and 102 (such as file servers, object stores, or SQL databases, among other examples). However, the content items 112 and 114 can also be stored in the same data repository.

The data orchestration system 100 includes a data retrieval component 110, a UDR processing pipeline 120, and a data emission component 130. The data retrieval component 110 is configured to communicate or interface with the data repositories 101 and 102 to facilitate the retrieval of the content items 112 and 114. Example suitable data repositories include computers, servers, storage systems, and third-party platforms (such as software-as-a-service (SaaS) platforms), among other examples. In some implementations, the data retrieval component 110 may store information identifying the data repositories 101 and 102 from which the data assets 112 and 114 can be retrieved. In some implementations, the data retrieval component 110 may detect or identify the data repositories 101 and 102 using network discovery tools (such as by querying Active Directory or performing port scans on the network).

The UDR processing pipeline 120 is configured to extract metadata from the content items 112 and 114 and arrange such metadata in the UDR documents 122 and 124, respectively. As used herein, the term “metadata” refers to any data and/or information that can be stored in or otherwise used to describe a particular content item. Example suitable metadata can include a source or owner of the content item, a content type associated with the content item (indicating whether the content item is an image, video, slideshow, word processing document, SQL database, JSON file, or HTML document), a schema associated with the content item (describing how data is formatted, presented, or otherwise stored in the content item), and the values for various keys defined by the schema, among other examples.

Aspects of the present disclosure recognize that different types of content items often have different schemas for storing data. For example, the contents of a text document (where data is arranged in sentences, paragraphs, and/or pages) may have a different layout or geometry than the contents of a relational database (where data is arranged in tables having rows and/or columns). In some implementations, the UDR processing pipeline 120 may arrange the metadata in each of the UDR documents 122 and 124 according to a common schema shared by all UDR documents. In this way, UDR provides a universal data format for storing and/or searching metadata extracted from heterogenous data types. For example, an application can search the UDR documents 122 and 124 for information about the data stored in the content items 112 and 114, respectively, without any knowledge of their content types or the data repositories in which they are stored.

The data emission component 130 is configured to communicate or interface with the UDR repository 103 to facilitate the storage or emission of the UDR documents 122 and 124. Example suitable UDR repositories include computers, servers, storage systems, and/or third-party platforms that are connected or otherwise accessible to processing systems and/or applications configured for searching, retrieving, using, and/or performing additional processing on the UDR documents (such as for analytics or machine learning). In some implementations, the data emission component 130 also may emit additional data (such as the original content items 112 and 114) to be stored in association with the UDR documents 122 and 124. For example, the content items 112 and 114 and the UDR documents 122 and 124 can be stored in a relational database (spanning one or more data repositories) that maps each UDR document to its associated content item.

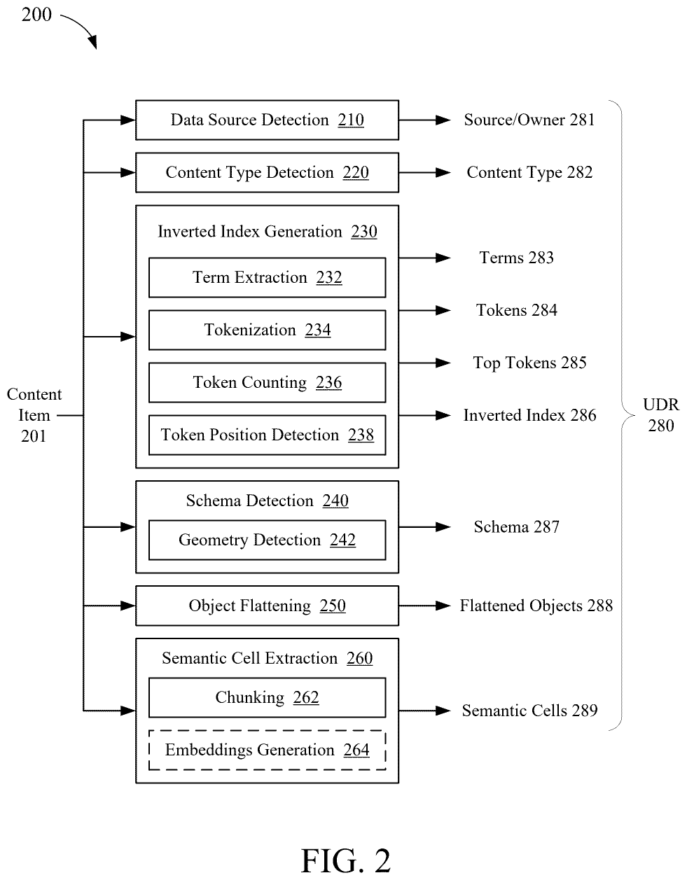

FIG. 2 shows an example UDR extraction system 200, according to some implementations. In some implementations, the UDR extraction system 200 may be one example of the UDR processing pipeline 120 of FIG. 1. More specifically, the UDR extraction system 200 is configured to generate or extract UDR metadata 280 from a content item 201. With reference to FIG. 1, the content item 201 may be one example of any one of the content items 112 or 114 and the UDR metadata 280 may be one example of any one of the UDR documents 122 or 124.

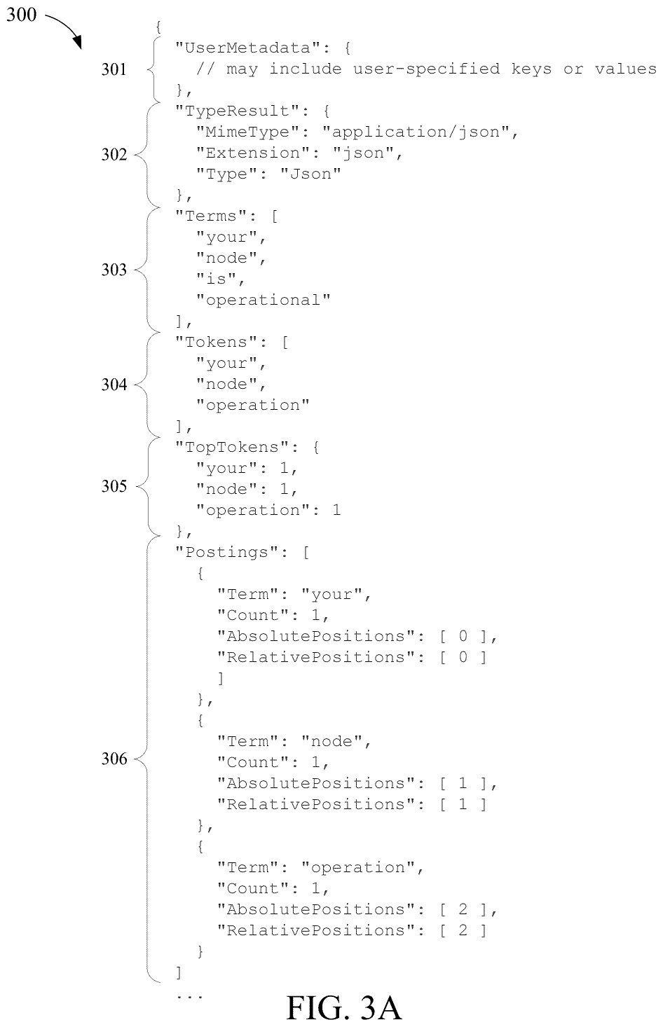

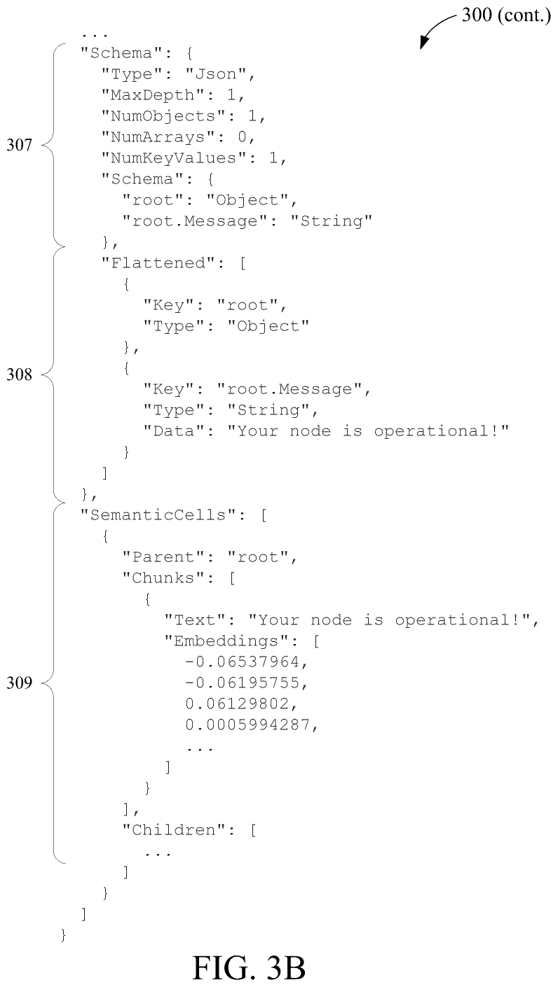

The UDR extraction system 200 includes a data source detection component 210, a content type detection component 220, an inverted index generation component 230, a schema detection component 240, an object flattening component 250, and a semantic cell extraction component 260. The data source detection component 210 is configured to extract source and/or owner metadata 281, including details about the source repository where the content item 201 resides and/or details about the owners of the content item 201 (when available). Example suitable ownership details include file system ownership and object/bucket ownership, among other examples. The remaining components of the UDR extraction system 200 are described herein with reference to FIGS. 3A and 3B, which show an example UDR document 300, according to some implementations. More specifically, the example UDR document 300 may be extracted by the UDR extraction system 200 from a JSON file containing the text string: “Your node is operational!”

The content type detection component 220 is configured to extract details about the content type 282 of the content item 201 (such as a Multipurpose Internet Mail Extensions (MIME) type and/or other media type). In some implementations, the content type detection component 220 may determine the content type 282 through data magic signature analysis of the content item 201. In some other implementations, the content type 282 may be provided (explicitly) to the content type detection component 220 (or the UDR extraction system 200). With reference for example to FIG. 3A, the UDR document 300 includes a “TypeResult” object 302 which indicates that the content item from which the UDR document 300 is extracted (also referred to as the “associated content item”) is a JSON file. In some implementations, the “TypeResult” object 302 may be one example of the content type 282 of FIG. 2.

The inverted index generation component 230 is configured to generate an inverted index 286 of tokens contained in the content item 201. As used herein, the term “token” refers to any fundamental unit of data (such as a character, word, or text string) that can be processed by a machine or computer (such as a natural language processing (NLP) model). An inverted index is a data structure that indicates the absolute and/or relative positions of each token in the content item 201. In some implementations, the inverted index generation component 230 may include a term extraction subcomponent 232, a tokenization subcomponent 234, a token counting subcomponent 236, and a token position detection subcomponent 238.

The term extraction subcomponent 232 is configured to extract or enumerate each of the terms 283 (such as words or text strings) included in the content item 201. With reference for example to FIG. 3A, the UDR document 300 includes a “Terms” object 303 which includes a listing of every word extracted from the associated content item. In some implementations, the “Terms” object 303 may be one example of the terms 283 of FIG. 2. In the example of FIG. 3A, the “Terms” object 303 is shown to include the words, “your,” “node,” “is,” and “operational.”

The tokenization subcomponent 234 is configured to normalize or reduce the terms 283 into corresponding tokens 284. Example normalization techniques include lemmatization or stemming (reducing words to their stems or lemmas, such as by eliminating prefixes and/or suffixes from root words), min/max length comparison (eliminating words that are shorter than a minimum length and/or longer than a maximum length), and dictionary removal (eliminating words according to a predefined list, which may include “a,” “the,” and various other function words), among other examples. With reference for example to FIG. 3A, the UDR document 300 includes a “Tokens” object 304 which includes a listing of every token in the associated content item. In some implementations, the “Tokens” object 304 may be one example of the Tokens 284 of FIG. 2. In the example of FIG. 3A, the “Tokens” object 304 is shown to include the tokens, “your,” “node,” and “operation” (as a result of stemming the word, “operational”), and excludes the functional word, “is.”

The token counting subcomponent 236 is configured to count or determine the frequency of each of the tokens 284 and produce a list of top tokens 285 that includes a number (N) of the highest-frequency tokens (where N can be a user-specified value or threshold). With reference for example to FIG. 3A, the UDR document 300 includes a “TopTokens” object 305 which includes a listing of the 3 highest-frequency tokens, as well as their corresponding count values, in the associated content item. In some implementations, the “TopTokens” object 305 may be one example of the listing of top tokens 285 of FIG. 2. In the example of FIG. 3A, the “TopTokens” object 305 is shown to include the tokens, “your” (count=1), “node” (count=1), and “operation” (count=1).

The token position detection subcomponent 238 is configured to determine the absolute and/or relative positions of each of the tokens 284 in relation to the content item 201, which are used to create the inverted index 286 (also referred to as “postings”). Each absolute position uniquely identifies the location of a token relative to the entirety of the content item 201. By contrast, each relative position identifies the location of a token relative to a portion or subsection of the content item 201 (such as a sentence or paragraph). As such, multiple tokens can have the same relative positions. With reference for example to FIG. 3A, the UDR document 300 includes a “Postings” object 306 which includes the absolute and relative positions of each token in the associated content item. In some implementations, the “Postings” object 306 may be one example of the inverted index 286. In the example of FIG. 3A, the tokens, “your,” “node,” and “operation,” are shown to have absolute positions 0, 1, and 2, respectively (where the relative positions are the same as the absolute positions because the content item only has one sentence).

The schema detection component 240 is configured to determine a schema 287 associated with the content item 201. As used herein, the term “schema” refers to the structure or format of structured or semi-structured content (including files with implicit hierarchical structures, such as JSON, XML, and HTML files). Example suitable schema include a name for each key in the content item, a data type for each value in the content item (such as Boolean, integer, string, timestamp, or Internet protocol (IP) address), and whether each of the values is allowed to be null (or empty), among other examples. In some implementations, the schema detection component 240 may include a geometry detection subcomponent 242 to detect the geometry of a structed or semi-structed content item. Example suitable geometry includes a number of nested objects in the content item, a number of nested arrays in the content item, a number of keys in the content item, a number of values in the content item, a maximum depth of the content item, and whether the content item includes any irregularities or parsing concerns, among other examples. With reference for example to FIG. 3B, the UDR document 300 includes a “Schema” object 307 which describes the schema of the associated content item. In some implementations, the “Schema” object 307 may be one example of the schema 287 of FIG. 2. In addition to the schema structure shown in FIG. 3B, the “Schema” object 307 indicates that the content item is a JSON file having the following geometry: maximum depth equal to 1, number of objects equal to 1, number of arrays equal to 0, and number of key values equal to 1.

The object flattening component 250 is configured to produce a flattened representation of objects 288 in the content item 201. More specifically, the object flattening component 250 reduces a dimensionality of each object in a manner more suitable for processing by a machine or computer (such as an NLP model). In some implementations, the flattened representation of each object may include a key containing one or more identifiers indicating a position of data in the content item 201 as well as the value of the key at the indicated position. With reference for example to FIG. 3B, the UDR document 300 includes a “Flattened” object 308 which includes a flattened representation of the associated content item. In some implementations, the “Flattened” object 308 may be one example of the flattened representation of objects 288 of FIG. 2. In the example of FIG. 3B, the “Flattened” object 308 indicates that the associated content item includes a first key (“root”) having a first type (“object”) and a second key (“root.Message”) having a second type (“string”), where the second key has the data value: “Your node is operational!”

The semantic cell extraction component 260 is configured to parse or arrange the tokens of the content item 201 into one or more semantic cells 289 based on a semantic structure of the content item 201. As used herein, the term “semantic cell” refers to a grouping of tokens or data that are semantically related. In some implementations, the semantic structure may be specified by a user of the UDR extraction system 200. Example suitable semantic cells include sentences, paragraphs, pictures, or slides. A semantic cell can also be a “child” of another semantic cell (such as a sentence within a paragraph). In some implementations, the semantic cell extraction component 260 may include a chunking subcomponent 262 to further segment each semantic cell (or arrange the tokens within each semantic cell) into more granular chunks. As used herein, the term “chunk” refers to a subgrouping of tokens or data that are related to a given semantic cell. For example, chunks may be used to break down a semantic cell into smaller groups of data that can be processed more efficiently by a machine or computer (such as an NLP model) or yield more accurate and/or precise results. With reference for example to FIG. 3B, the UDR document 300 includes a “SemanticCells” object 309 which includes a listing of semantic cells in the associated content item. In some implementations, the “SemanticCells” object 309 may be one example of the semantic cells 289 of FIG. 2. In the example of FIG. 3B, each semantic cell represents a respective sentence in the associated content item, and a chunk is a grouping of up to 4 words in each semantic cell. Thus, as shown in FIG. 3B, the “SemanticCells” object 309 includes the chunk of text: “Your node is operational!”

In some implementations, the semantic cell extraction component 260 may further include an embeddings generation subcomponent 264 to generate embeddings for each chunk of data in the semantic cells 289. An embedding is a mapping of any discrete (or categorical) variable to a vector of continuous numbers (such as a floating point number). Embeddings are often used as inputs to neural networks (or may be output by an embeddings layer of a neural network) due to their reduced dimensionality while representing categories in the transformed space. A neural network is a particular for of machine learning in which the inferencing and training phases are performed over multiple layers (similar to a biological nervous system). Embeddings can be used to calculate the cosine similarity between nearest neighbors, which is essential to the tasks of training and inferencing for many neural networks. Aspects of the present disclosure recognize that a given chunk of data may be mapped to different embeddings for different neural networks. Thus, in some implementations, the embeddings generation component 264 may generate the embeddings based on a user-specified neural network. As shown in FIG. 3B, the “SemanticCells” object 309 includes a list of “Embeddings” (floating point numbers) representing the text, “Your node is operational!” according to an NLP model.

In some implementations, the UDR metadata 280 may include additional metadata (not shown for simplicity) that can be provided by a user of the UDR extraction system 200. For example, the additional metadata may be provided in the form of a dictionary (such as key-value pairs). With reference for example to FIG. 3A, the UDR document 300 further includes a “UserMetadata” object 301 which may include user-specified keys and/or values. In some implementations, the “UserMetada” object 301 may be one example of the additional metadata included in the UDR metadata 280 of FIG. 2.

Any specific text, formatting, or ordering of elements shown in the example UDR document 200 are intended to be illustrative rather than restrictive. These examples are provided to demonstrate the principles of the present disclosure and to highlight various types of metadata and/or information that can be extracted and stored in a UDR document. Various modifications, substitutions, alterations, and adaptations can be made to the examples herein without departing from the scope of the present disclosure. In some aspects, the UDR document 200 also may be customized to user preferences. Example suitable customization options may include, among other examples, changing the amount and/or types of metadata to be stored in a UDR document. Specific text, features, structures, or other characteristics described in connection with any particular example are included for illustration and clarity of understanding only and should not be interpreted as limiting the claims.

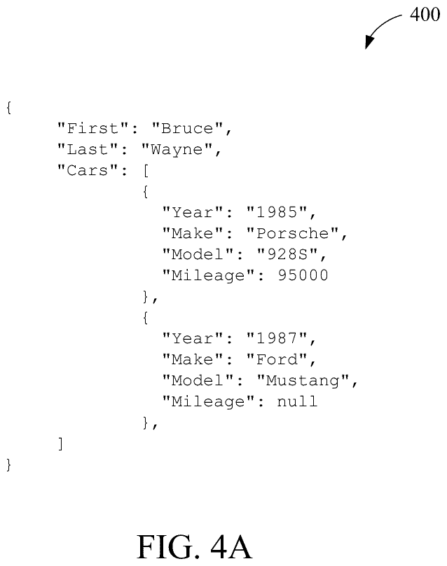

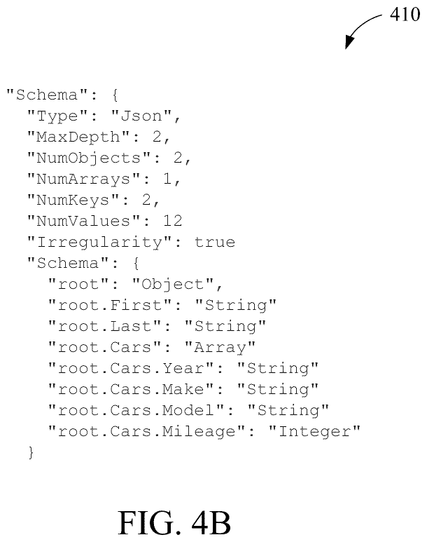

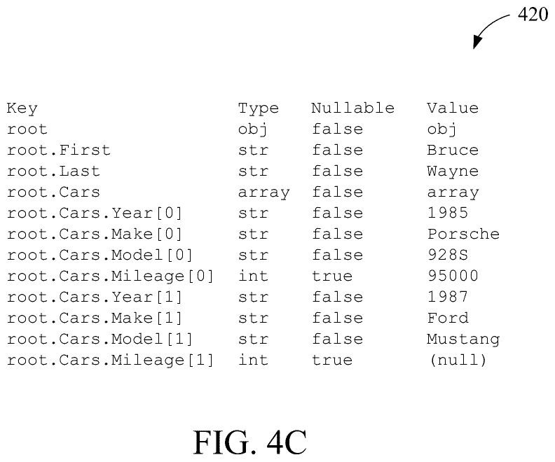

FIG. 4A shows an example content item 400 in the form of a JSON file. FIG. 4B shows an example schema 410 that can be extracted from the content item 400 of FIG. 4A, according to some implementations. In some implementations, the schema 410 may be one example of the schema 287 of FIG. 2. In addition to the schema structure shown in FIG. 4B, the schema 410 indicates that the content item 400 is a JSON file having the following geometry: maximum depth equal to 2, a number of objects equal to 2, number of arrays equal to 1, number of keys equal to 2, and number of values equal to 12. In some implementations, the schema detection component 240 may further detect an irregularity in the schema 410 of the content item 400 due to the trailing comma (“,”) after the list of cars. FIG. 4C shows an example flattened representation 420 of objects included in the content item 400 of FIG. 4A, according to some implementations. In some implementations, the flattened representation 420 may be one example of the flattened objects 288 of FIG. 2.

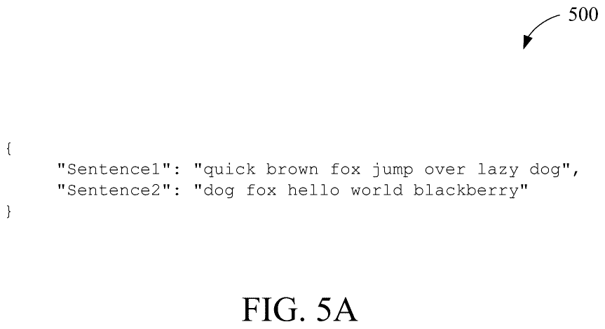

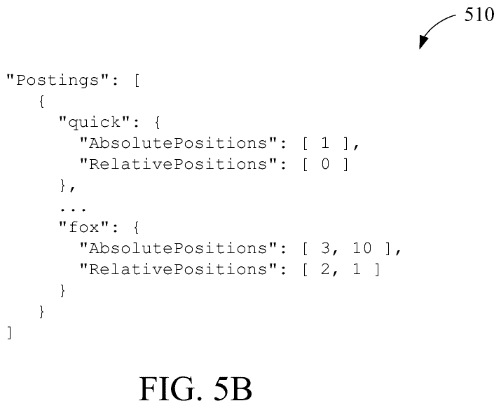

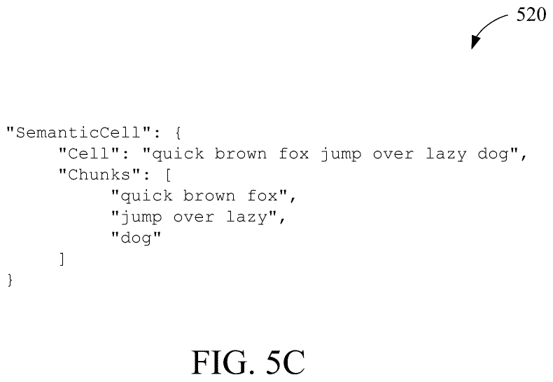

FIG. 5A shows another example content item 500 in the form of a JSON file.

FIG. 5B shows an example inverted index 510 that can be generated based on the content item 500 of FIG. 5A, according to some implementations. In some implementations, the inverted index 510 may be one example of the inverted index 286 of FIG. 2. In the example of FIG. 5A, the content item 500 can be represented by the token stream: “Sentence1 quick brown fox jump over lazy dog Sentence2 dog fox hello world blackberry.” Thus, as shown in FIG. 5B, the token, “quick,” has an absolute position equal to 1 in the token stream and a relative position equal to 0 in Sentence1. By contrast, the token, “fox,” has absolute positions 3 and 10 in the token stream and relative positions 2 and 1 in Sentence1 and Sentence2, respectively. FIG. 5C shows an example semantic cell 520 representation of the content item 500 of FIG. 5A, according to some implementations. In some implementations, the semantic cell 520 may be one example of the semantic cells 289 of FIG. 2. In the example of FIG. 5C, each semantic cell represents a respective sentence in the content item 500, and each chunk is a grouping of up to 3 consecutive words in each semantic cell.

With a common metadata format, users can execute queries against UDR documents, which have a consistent schema and format, without having to understand the intricacies and/or complexities of the source data format or the source data repositories themselves. Thus, UDR may be analogous to a dictionary of key-value pairs, where some of the key-value pairs contain discrete values and some of the key-value pairs contain nested dictionaries of values. In some implementations, UDR enables a user to query data, regardless of its source repository or source content type, along any number of dimensions. Example suitable dimensions include presence of a keyword, presence of multiple keywords, presence of multiple keywords with minimum and maximum distances amongst them, content-type, source repository, data owner, existence of schema elements, existence of schema elements with specific values or values that fall within a given range (such as a Boolean expression), and similarity of embeddings based on any number of search mechanisms (such as cosine similarity, nearest neighbor, or inner product), among other examples.

Aspects of the present disclosure recognize that one of the primary drivers behind data management processes is to derive contextual understanding of the source data, extract features of the data that are considered important, perform transformations against the data to cause such data to conform to the needs of consuming applications, and create alternative representations of the data that are useful to the consuming applications. For example, hybrid search is a technique that centers around a desire to be able to search for data assets along any number of dimensions, concurrently, such as the existence of a keyword, a specific content-type (or array of different content-types), existence of properties in the data's schema, existence (or the discrete value) of a given value in the data's schema, distance among a set of tokens (or words), and the vector similarity of the vectorized document contents compared to the vectors generated for a given user prompt. Existing data catalogs do not store vectorized data, such as data that has been processed through a neural network model and converted to an array of embeddings for use by such neural networks. However, by adding embeddings to the UDR metadata 280, aspects of the present disclosure can create a catalog or repository of metadata, user metadata, and vectorized information that enables hybrid search functionality.

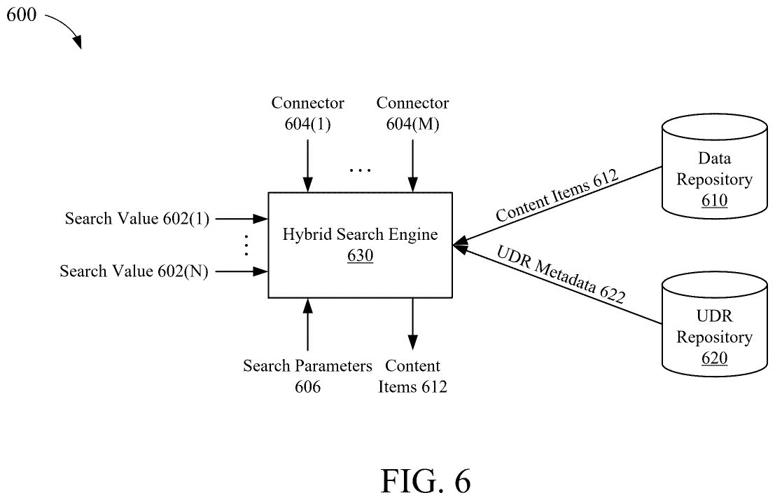

FIG. 6 shows an example data management system 600, according to some implementations. The data management system 600 includes a data repository 610, a UDR repository 620, and a hybrid search engine 630. The data repository 610 is configured to store content items 612. In some implementations, the content items 612 may be examples of any of the content items 201, 400, or 500 of FIGS. 2, 4A, and 5A, respectively. The UDR repository 620 is configured to store UDR metadata 622 associated with the content items 612. In some implementations, the UDR metadata 622 may be one example of the UDR metadata 280 or the UDR document 300 of FIGS. 2 and 3, respectively.

The hybrid search engine 630 is configured to search the UDR repository 620 for UDR metadata 622 matching any number (N) of search values 602(1)-620(N) connected by any number (M) of connectors 604(1)-604(M) and retrieve one or more content items 612 associated with the matching UDR metadata 622. For example, each of the search values 602(1)-602(N) may be a value that can be found or derived from the UDR metadata 622, and each of the connectors 604(1)-604(M) may be a Boolean operator that describes a logical relationship between two or more of the search values 602(1)-602(N). In some implementations, the hybrid search engine 610 also may allow a user to specify one or more search parameters 606 for limiting the scope of the search and/or the presentation of the results. More specifically, the hybrid search engine 630 may expose a search interface and domain-specific language (DSL) that allows a user to query the UDR repository 620 to find content items 612 that meet the supplied criteria. For example, the search interface may allow the user to write logical queries that contain multiple Boolean operators.

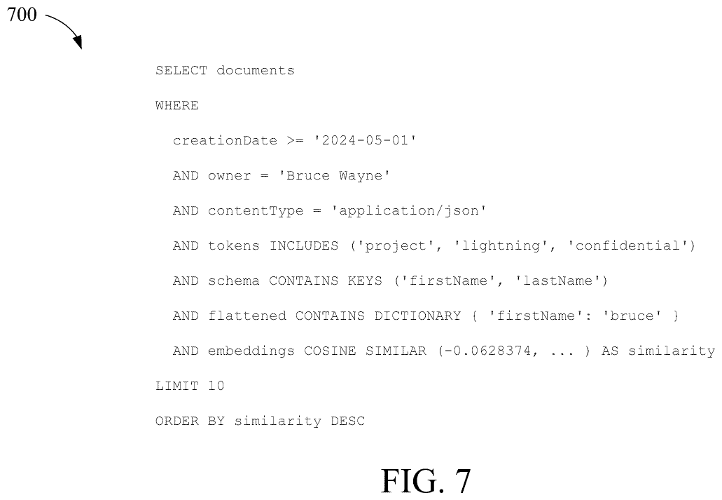

FIG. 7 shows an example search query 700 that can be provided as input to the hybrid search engine 630 of FIG. 6. As shown in FIG. 7, the query 700 includes the following search terms (which may be examples of the search values 620(1)-620(N)): “creationDate>=‘2024 May 1’”; “owner=‘Bruce Wayne’”; “contentType=‘application/json’”; “tokens INCLUDES (‘project’, ‘lightning’, ‘confidential’)”; “schema CONTAINS KEYS (‘firstName’, ‘lastName’)”; “flattened CONTAINS DICTIONARY (‘firstName’: ‘bruce’)”; and “embeddings COSINE SIMILAR (−0.0628374, . . . ) AS similarity.” The search terms are all connected via AND logical operators (which may be examples of the connectors 604(1)-604(M)). The search query 700 also specifies a limit of 10 search results to be arranged in descending order of similarity.

The search query 700 should retrieve up to 10 documents that were created on or after May 1, 2024 and owned by “Bruce Wayne,” that are of the content-type application/Jason, containing the words “project,” “lightning,” and “confidential,” with a schema that has the keys “firstName” and “lastName,” where the value of the “firstName” key is set to “bruce” within the data and the embeddings are cosine similar to the supplied vectors. The resultant set would then be ordered by the similarity score yielded form the cosine similarity search.

Many generative AI applications are powered by large language models (LLMs) previously trained on a dataset to help craft responses to user prompts (or queries). For example, an AI “chatbot” may simulate human conversation by processing user queries (also referred to as “prompts”) through an LLM which infers a response (also referred to as a “completion”) to the user query. However, the knowledge base of the LLM is generally limited to the data on which it was trained. Retrieval augmented generation (RAG) can expand the knowledge base of an LLM by providing additional contextual information that can be used by the LLM to infer the completion. For example, a RAG architecture may search one or more data repositories for relevant information associated with the prompt (based on cosine similarity and/or distance) to supply the LLM with additional context. The quality of the completion inferred by the LLM largely depends on the ability of the RAG architecture to search and retrieve content relevant to the query. In some aspects, UDR can improve upon existing RAG architectures by enabling more granular searches for relevant content along a greater number of dimensions.

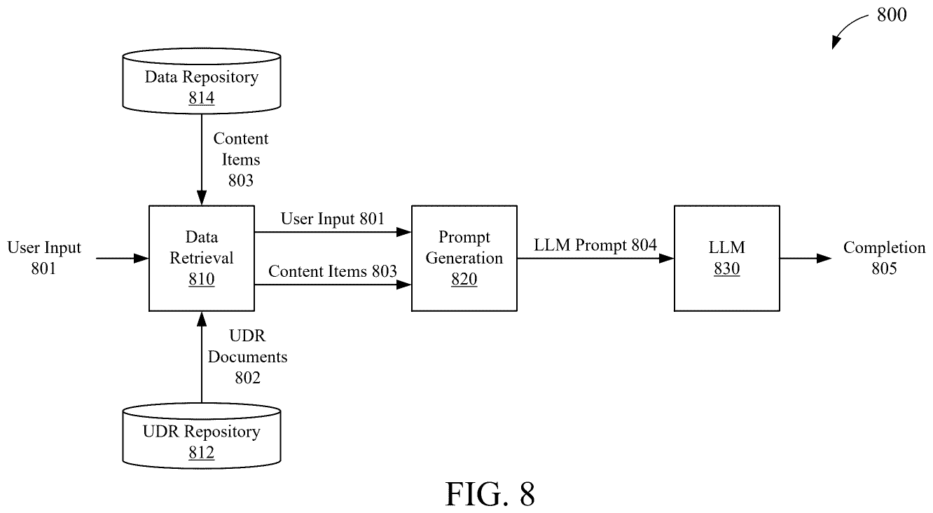

FIG. 8 shows a block diagram of an example RAG system 800, according to some implementations. The RAG system 800 is configured to receive user input 801 and infer a completion 805 for the user input 801 based on an LLM 830. More specifically, the RAG system 800 may retrieve additional contextual information related to the user input 801 and provide such additional context to the LLM 830 for generating the completion 805.

The RAG system 800 includes a data retrieval component 810 and a prompt generation component 820. The data retrieval component 810 is configured to receive the user input 801 and retrieve content items 803 related to the user input 801. In some implementations, the data retrieval component 810 may be one example of the hybrid search engine 630 of FIG. 6. More specifically, the data retrieval component 810 is configured to generate a search query based on the user input 801 and search a UDR repository 812 for UDR documents 802 matching the search query. The data retrieval component 810 can further retrieve one or more content items 803, from a data repository 814, associated with the matching UDR documents 802.

As described with reference to FIG. 6, the search query can include any number of search values connected by any number of connectors (or Boolean operators). In some implementations, the data retrieval component 810 may perform one or more pre-processing operations on the user input 801 to generate the search query. Example suitable pre-processing operations include stemming or lemmatizing text, mapping portions of the user input 801 to respective vector embeddings or otherwise transforming the user input 801 in a way that expands the search query along a greater number of dimensions associated with the UDR repository 812 (such as described with reference to FIG. 2).

The prompt generation component 820 is configured to generate an LLM prompt 804 based on the user input 801 and the content items 803. In some implementations, the prompt generation component 820 may implement various prompt engineering techniques to query the LLM 830 for a response to the user input 801 based, at least in part, the content items 803. For example, the LLM prompt 804 may include the user input 801 and the content items 803, as well as instructions to respond to the user input 801 using the provided content items 803 for context. The prompt generation component 820 emits the LLM prompt 804 to the LLM 830.

The LLM 830 infers or generates the completion 805 based on the LLM prompt 804. In some implementations, the LLM 830 may be stored and executed locally, for example, as an integrated component of the RAG system 800 (or the underlying computing platform or architecture). In some other implementations, the LLM 830 may be hosted remotely, for example, on a server or computing device that is separate from the RAG system 800. For example, the prompt generation component 820 may communicate with the LLM 830 via an application programming interface (API).

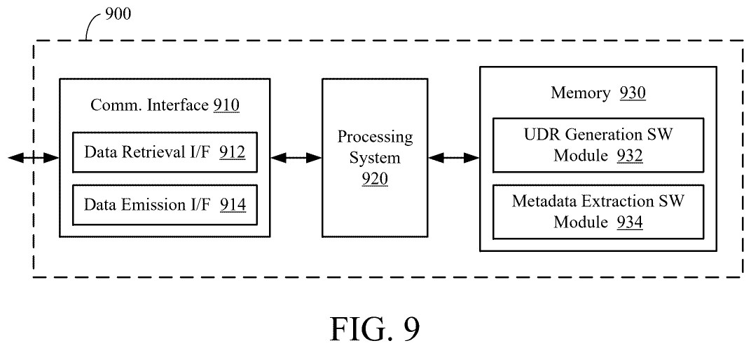

FIG. 9 shows another block diagram of an example data orchestration system 900, according to some implementations. In some implementations, the data orchestration system 900 may be one example of the UDR processing pipeline 120 of FIG. 1 or the UDR extraction system 200 of FIG. 2. More specifically, the data orchestration system 900 is configured to construct a searchable database based on UDR metadata extracted from various content items.

The orchestration system 900 includes a communication interface 910, a processing system 920, and a memory 930. The communication interface 910 is configured to communicate with one or more data repositories. More specifically, the communication interface 910 includes a data retrieval interface (I/F) 912 for communicating with one or more input data repositories (such as any of the data repositories 101 or 102 of FIG. 1) and a data emission interface (I/F) 914 for communicating with one or more output data repositories (such as the UDR repository 103 of FIG. 1).

In some implementations, the data retrieval interface 912 may receive a first content item associated with a first content type and may further receive a second content item associated with a second content type different than the first content type. In some implementations, the data emission interface 914 may store a first document and a second document associated with the first content item and the second content item, respectively, in a data repository that is searchable based on a predefined schema.

The memory 930 includes a non-transitory computer-readable medium (including one or more nonvolatile memory elements, such as EPROM, EEPROM, Flash memory, or a hard drive, among other examples) that can store the following software (SW) modules: a UDR generation SW module 932 to extract metadata from each of the first content item and the second content item; and a metadata extraction SW module 934 to generate the first document so that the first document includes the metadata from the first content item arranged according to the predefined schema, and to generate the second document so that the second document includes the metadata from the second content item arranged according to the predefined schema.

The processing system 920 includes any suitable one or more processors capable of executing scripts or instructions of one or more software programs stored in the data orchestration system 900 (such as in the memory 930). For example, the processing system 920 can execute the UDR generation SW module 932 to extract metadata from each of the first content item and the second content item. The processing system 920 can also execute the metadata extraction SW module 934 to generate the first document so that the first document includes the metadata from the first content item arranged according to the predefined schema, and to generate the second document so that the second document includes the metadata from the second content item arranged according to the predefined schema.

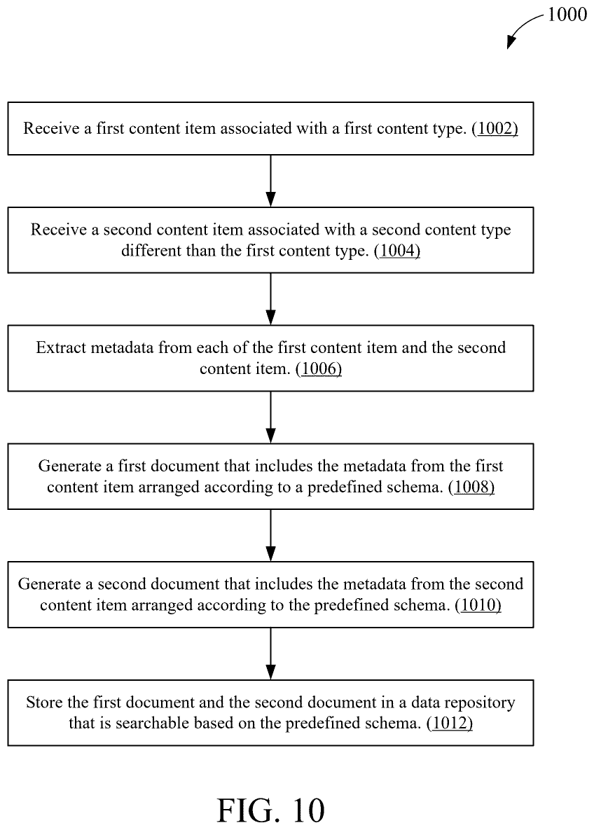

FIG. 10 shows an illustrative flowchart depicting an example operation 1000 for constructing a searchable database, according to some implementations. In some implementations, the example operation 1000 may be performed by a data processing pipeline such as the data orchestration system 900 of FIG. 9.

The data processing pipeline receives a first content item associated with a first content type (902). The data processing pipeline also receives a second content item associated with a second content type different than the first content type (904). The data processing pipeline extracts metadata from each of the first content item and the second content item (906). In some implementations, the metadata from the first and second content items may include the first content type and the second content type, respectively. The data processing pipeline generates a first document that includes the metadata from the first content item arranged according to a predefined schema (908). The data processing pipeline also generates a second document that includes the metadata from the second content item arranged according to the predefined schema (910). The data processing pipeline further stores the first document and the second document in a data repository that is searchable based on the predefined schema (912).

In some implementations, the data processing pipeline may further determine a source or owner of the first content item and determine a source or owner of the second content item. In such implementations, the metadata from the first and second content items may include the source or owner of the first content item and the source or owner of the second content item, respectively.

In some aspects, the data processing pipeline may further determine a first schema associated with the first content item and determine a second schema associated with the second content item. In such aspects, the metadata from the first and second content items may include the first and the second schemas, respectively. In some implementations, the first schema may include a geometry of the first content item and the second schema may include a geometry of the second content item. In some implementations, the first schema may be different than the second schema.

In some aspects, the data processing pipeline may further generate a first flattened representation of a first object in the first content item so that the first flattened representation has a lower dimensionality than the first object and also may generate a second flattened representation of a second object in the second content item so that the second flattened representation has a lower dimensionality than the second object. In such aspects, the metadata from the first and second content items including the first and second flattened representations, respectively.

In some aspects, the metadata from the first content item may include a listing of terms included in the first content item. In some implementations, the data processing pipeline may further reduce the listing of terms to one or more tokens based on one or more normalization operations. In such implementations, the metadata from the first content item may further include the one or more tokens. In some implementations, the one or more normalization operations include lemmatization, minimum length comparison, maximum length comparison, or dictionary removal.

In some aspects, the data processing pipeline may further determine a frequency of each of the one or more tokens. In such aspects, the metadata from the first content item may further include the frequency of each of the one or more tokens. In some implementations, the data processing pipeline may further identify a threshold number of tokens having the highest frequencies among the one or more tokens. In such implementations, the metadata from the first content item further include an indication of the tokens identified as having the highest frequencies among the one or more tokens.

In some aspects, the data processing pipeline may further determine a respective position of each token of the one or more tokens in the first content item. In such aspects, the metadata from the first content item may further include the position of each token of the one or more tokens. In some implementations, the position of each token may be an absolute position of the token in the first content item. In some other implementations, the position of each token may be a relative position of the token in a portion of the first content item.

In some aspects, the data processing pipeline may further arrange the one or more tokens into one or more semantic cells based on a semantic structure of the first content item. In such aspects, the metadata from the first content item may further include the one or more semantic cells. In some implementations, each of the one or more semantic cells represents a respective sentence, paragraph, picture, or slide.

In some implementations, the data processing pipeline may further segment each semantic cell of the one or more semantic cells into one or more chunks of tokens based at least in part on a number of tokens, of the one or more tokens, in the semantic cell. In such implementations, the metadata from the first content item may further include the one or more chunks of tokens associated with each semantic cell of the one or more semantic cells.

In some implementations, the data processing pipeline may further maps the one or more chunks of tokens to one or more vector embeddings, respectively, associated with a neural network model. In such implementations, the metadata from the first content item may further include the one or more vector embeddings.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

In the foregoing specification, implementations have been described with reference to specific examples thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

As used herein, a phrase referring to “at least one of” a list of items refers to any combination of those items, including single members. As an example, “at least one of: a, b, or c” is intended to cover: a, b, c, a-b, a-c, b-c, and a-b-c.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

What is claimed is:

1. A method of constructing a searchable database, comprising:
receiving a first content item associated with a first content type;
receiving a second content item associated with a second content type different than the first content type;
extracting metadata from each of the first content item and the second content item;
generating a first document that includes the metadata from the first content item arranged according to a predefined schema;
generating a second document that includes the metadata from the second content item arranged according to the predefined schema; and
storing the first document and the second document in a data repository that is searchable based on the predefined schema.

2. The method of claim 1, wherein the metadata from the first and second content items include the first content type and the second content type, respectively.

3. The method of claim 1, further comprising:
determining a source or owner of the first content item; and
determining a source or owner of the second content item, the metadata from the first and second content items including the source or owner of the first content item and the source or owner of the second content item, respectively.

4. The method of claim 1, further comprising:
determining a first schema associated with the first content item; and
determining a second schema associated with the second content item, the metadata from the first and second content items including the first and the second schemas, respectively.

5. The method of claim 4, wherein the first schema includes a geometry of the first content item and the second schema includes a geometry of the second content item.

6. The method of claim 4, wherein the first schema is different than the second schema.

7. The method of claim 1, further comprising:
generating a first flattened representation of a first object in the first content item so that the first flattened representation has a lower dimensionality than the first object; and
generating a second flattened representation of a second object in the second content item so that the second flattened representation has a lower dimensionality than the second object, the metadata from the first and second content items including the first and second flattened representations, respectively.

8. The method of claim 1, wherein the metadata from the first content item includes a listing of terms included in the first content item.

9. The method of claim 8, further comprising:
reducing the listing of terms to one or more tokens based on one or more normalization operations, the metadata from the first content item further including the one or more tokens.

10. The method of claim 9, wherein the one or more normalization operations include lemmatization, minimum length comparison, maximum length comparison, or dictionary removal.

11. The method of claim 9, further comprising:
determining a frequency of each of the one or more tokens, the metadata from the first content item further including the frequency of each of the one or more tokens.

12. The method of claim 11, further comprising:
identifying a threshold number of tokens having the highest frequencies among the one or more tokens, the metadata from the first content item further including an indication of the tokens identified as having the highest frequencies among the one or more tokens.

13. The method of claim 9, further comprising:
determining a respective position of each token of the one or more tokens in the first content item, the metadata from the first content item further including the position of each token of the one or more tokens.

14. The method of claim 13, wherein the position of each token comprises an absolute position of the token in the first content item.

15. The method of claim 13, wherein the position of each token comprises a relative position of the token in a portion of the first content item.

16. The method of claim 9, further comprising:
arranging the one or more tokens into one or more semantic cells based on a semantic structure of the first content item, the metadata from the first content item further including the one or more semantic cells.

17. The method of claim 16, wherein each of the one or more semantic cells represents a respective sentence, paragraph, picture, or slide.

18. The method of claim 16, further comprising
segmenting each semantic cell of the one or more semantic cells into one or more chunks of tokens based at least in part on a number of tokens, of the one or more tokens, in the semantic cell, the metadata from the first content item further including the one or more chunks of tokens associated with each semantic cell of the one or more semantic cells.

19. The method of claim 18, further comprising:
mapping the one or more chunks of tokens to one or more vector embeddings, respectively, associated with a neural network model, the metadata from the first content item further including the one or more vector embeddings.

20. A data orchestration system comprising:
a processing system; and
a memory storing instructions that, when executed by the processing system, causes the data orchestration system to:
receive a first content item associated with a first content type;
receive a second content item associated with a second content type different than the first content type;
extract metadata from each of the first content item and the second content item;
generate a first document that includes the metadata from the first content item arranged according to a predefined schema;
generate a second document that includes the metadata from the second content item arranged according to the predefined schema; and
store the first document and the second document in a data repository that is searchable based on the predefined schema.
